(19) United States
(12) Patent Application Publication
(10) Pub. No.: US 2002/0122060 A1
(43) Pub. Date: Sep. 5, 2002

(54) Wizard generating HTML web pages using XML and XSL

(76) Inventor: Steven O. Markel, Highlands Ranch, CO (US)

Correspondence Address: The Law Offices of William W. Cochran, LLC, Suite 230, 3555 Stanford Road, Fort Collins, CO, 80525, US

(21) Appl. No.: 10/026,156

(22) Filed: Dec. 18, 2001

Related U.S. Application Data
(60) Provisional application No. 60/256,771, filed on Dec. 18, 2000.

(51) Int. Cl. G09G 5/00

(52) U.S. Cl. 345/760

(57) ABSTRACT

Disclosed is a system for generating HTML code for various HTML interfaces such as various set-top boxes using non-technical personnel. The system employs a graphic user interface such as wizard to allow a non-technical user to enter content data to be displayed on the HTML page. The content data is translated my a XML translator into XML code. An XSL parser for a particular HTML interface is used to translate the XML code into HTML code for each particular HTML interface.

### CROSS REFERENCE TO RELATED APPLICATIONS

This application claims the benefit of provisional application serial number 60/256,771, entitled “Wizard Generating HTML Web Pages Using XML and XSL”, filed Dec. 18, 2000 by Steven O. Markel.

### BACKGROUND OF THE INVENTION

a. Field of Invention

The present invention generally relates to interactive TV and more particularly to generation of web pages for use on interactive TV.

b. Description of the Background

Coding of HTML web pages for interactive TV has typically been performed by highly paid software writers that are capable of programming the HTML pages in HTML Java script. As long as the information presented is static and the web page does not need to be changed to a great extent over a period of time, this existing process for generating the HTML pages is acceptable. For example, during the airing of a particular program, only a few or possibly only one HTML interactive web page may be presented. Hence, the need for extensive preparation of HTML script is not necessary in such environments.

However, if extensive interactive web pages are required as part of the interactive presentation, expensive software writers will be required to generate the extensive HTML Java script.

Further, the need for expensive software writers is exacerbated by the fact that the HTML script must be written for several different set-top box interfaces such as AOLTV, WebTV, standard HTML Web, etc. In other words, various set-top boxes require different HTML script for presentation of the web page. Hence, software writers that have expertise in each of the different interfaces must be hired to write the HTML script. The availability of these software writers, especially on an intermittent basis, may severely impact the ability of the interactive program provider to produce the required HTML script for the various interfaces.

It would therefore be advantageous to provide a way to generate the HTML script for the various interfaces using non-experts in a simple and easy fashion.

### SUMMARY OF THE INVENTION

The present invention overcomes the disadvantages and limitations of the prior art by providing a system that allows non-experts to generate HTML and JavaScript code for various interfaces in a simple and easy fashion and in an expedited manner. The present invention uses wizards that are generated in visual basic code that provide a straightforward, simple interface for allowing non-expert personnel to enter information relating to the HTML web page that is desired to be generated and displayed as part of an interactive program. The wizards prompt the user (person generating the HTML web page) with simple and straightforward interfaces that are designed for entry of information relating to the web page presentation. The information entered into the wizards is then transformed into XML code. XSL parsers are then used to translate the XML code into the HTML script that is required for each of the different interfaces. The XSL parsers employ sets of rules that apply specifically to the various interfaces such as AOLTV, WebTV, etc. to generate HTML script that will properly display the HTML web page using the corresponding set-top box. In this fashion, HTML scripts can be generated for each of the different interfaces by non-technical, non-experts using simple wizard prompts.

The present invention may therefore comprise software structure for allowing non-technical users to enter content that can be displayed on various HTML interfaces comprising input graphics for prompting the user to insert the desired content to be displayed on the HTML page; a translator for translating the content to XML code; an XSL parser for translating the XML code into HTML code for a particular HTML interface device.

The present invention may further comprise a wizard for creation of interactive television content comprising: a graphical user interface; a prompt for identifying content to be entered; an input box for collecting the content to be entered; a prompt for identifying the start time; the start time being the time in the program that the content will be displayed; and an input box for collecting the said time.

The present invention may further comprise a software structure for the creation of interactive television content comprising: a mechanism for selecting a particular frame of a video program; and a wizard for collecting content, the wizard comprising a graphical prompt for identifying content to be entered by a user, and an input box for collecting content entered by the user.

The present invention may further comprise a 13. A software structure for the creation of content that can be displayed on multiple HTML interfaces comprising: a prompting wizard for collecting content from a user; a translator for translating the content into XML code; and a plurality of XSL parsers for translating the XML code into HTML code for a plurality of devices for displaying HTML code.

The present invention may further comprise a software system used by non-technical users for creating HTML code for a plurality of display devices comprising: a graphical prompt for soliciting user input; a translator for translating the user input into XML code; and a first XSL parser for translating the XML code into HTML code for a first HTML display device.

The present invention may further comprise a method of creating interactive content for a television program comprising: selecting a frame during said television program to display content; using a graphical interface to capture the content; translating the content into XML; parsing the XML using a first XSL parser into HTML code; displaying the HTML code with the television program in an interactive fashion on a first device.

The present invention may further comprise a method of generating HTML pages for various HTML interfaces by non-technical users comprising the steps of entering content information to be displayed on a HTML page in a graphic user interface; translating the content into XML code; translating the XML code into HTML code for a particular HTML interface using an XSL parser.

The advantages of the present invention are that interactive HTML pages can be generated and revised by non-technical personnel in a simple and easy manner. HTML pages can be generated for various different types of interfaces such as AOLTV set-top boxes, WebTV set-top boxes, etc. All that is needed to generate the different HTML web pages is to provide different XSL parsers that contain the set of rules that are necessary to generate the HTML pages for the various interfaces. For example, an XSL parser can be used to translate the XML code to generate HTML code for AOLTV set-top boxes. A separate and different XSL parser is used to translate the XML code into HTML code for an AOLTV box. Once the various XSL parsers have been generated, the HTML pages for each of these different interfaces can be readily generated without the necessity of employing specialized experts for each of these separate interfaces. In this manner, non-technical, non-experts can be used to generate and revise the HTML pages desired.

### BRIEF DESCRIPTION OF THE DRAWINGS

FIG. 1 is a schematic diagram illustrating the program code structure of the present invention.

FIG. 2 is a flow chart illustrating the process for generating HTML code for pre-selected HTML interfaces.

FIGS. 3 through 9 are a depiction of screen shots that are generated in accordance with one implementation of the present invention.

FIG. 10 is a flow diagram illustrating the processes performed in generating XML code from wizard responses.

FIG. 11 is a flow chart illustrating the processes performed by an XSL file in translating XML code.

### DETAILED DESCRIPTION OF THE INVENTION

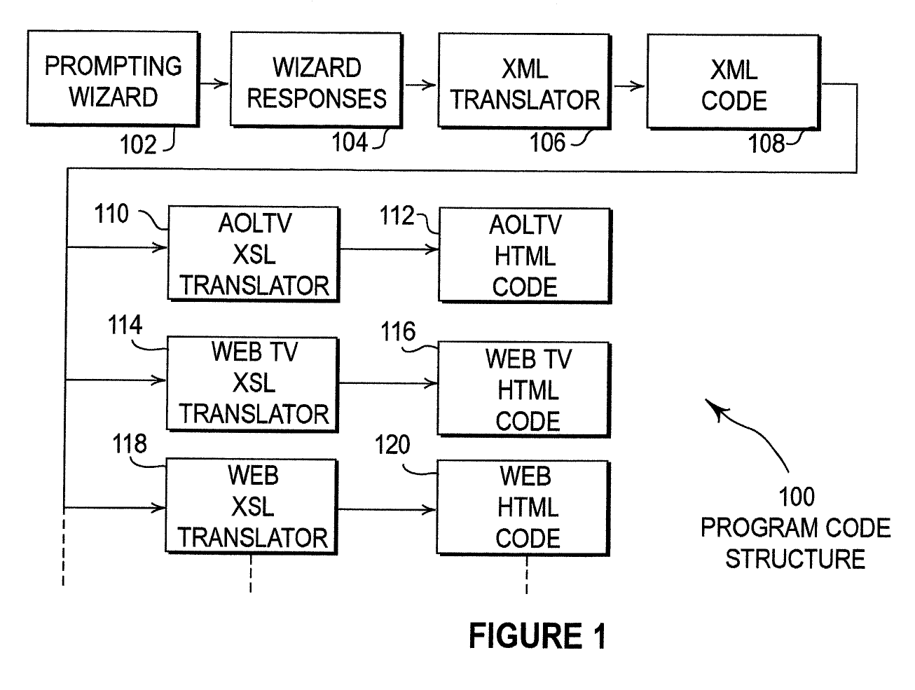

FIG. 1 illustrates the program code structure 100 that may be used in accordance with one implementation of the present invention. As shown in FIG. 1, prompting wizard 102 is used by a non-technical user to generate wizard responses 104. For example, the wizard can constitute a game wizard that prompts the user to enter a question and possible answers to that question. The wizard may also prompt the user to enter the correct answer from the selection of answers. The wizard responses 104 are then translated by an XML translator 106 described below. The XML translator gathers all of the wizard responses and generates XML code 108 based upon the wizard responses entered by the user. The XML code 108 is then translated by one or more translators 110, 114, 118. For example, the XML code may be translated by an AOLTV XSL translator 110 to generate AOLTV HTML code 112. In other words, the AOLTV XSL translator translates the XML code 108 into HTML code 112 that can be viewed on AOLTV interfaces such as an AOLTV set-top box. In a similar fashion, WebTV XSL translator 114 translates the XML code 108 into HTML code 116 that can be displayed by a WebTV set-top box. Also, Web XSL translator 118 translates the XML code 108 to generate HTML code 120 that can be viewed as a normal web page using a standard browser. Other XSL translators, of course, can be generated for any particular type of interface that requires custom HTML code.

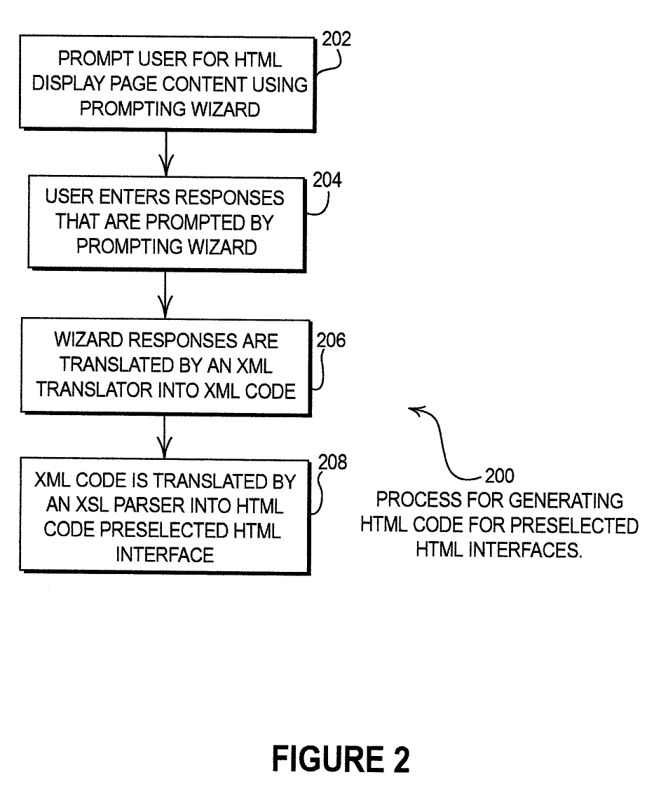

FIG. 2 is a flow diagram 200 illustrating the processes for generating HTML code for pre-selected HTML interfaces. At step 202, the user is prompted for content that will be displayed on a HTML display page by a prompting wizard such as prompting wizard 102. At step 204, the user enters the responses that are prompted by the prompting wizard. At step 206, the wizard responses are translated by a XML translator such as XML translator 106 into XML code 108. At step 208, the XML code 108 is translated by an XSL parser, such as XSL parsers 110, 114, 118, into HTML code such as HTML code 112, 116, 120, respectively, for each of the pre-selected HTML interfaces.

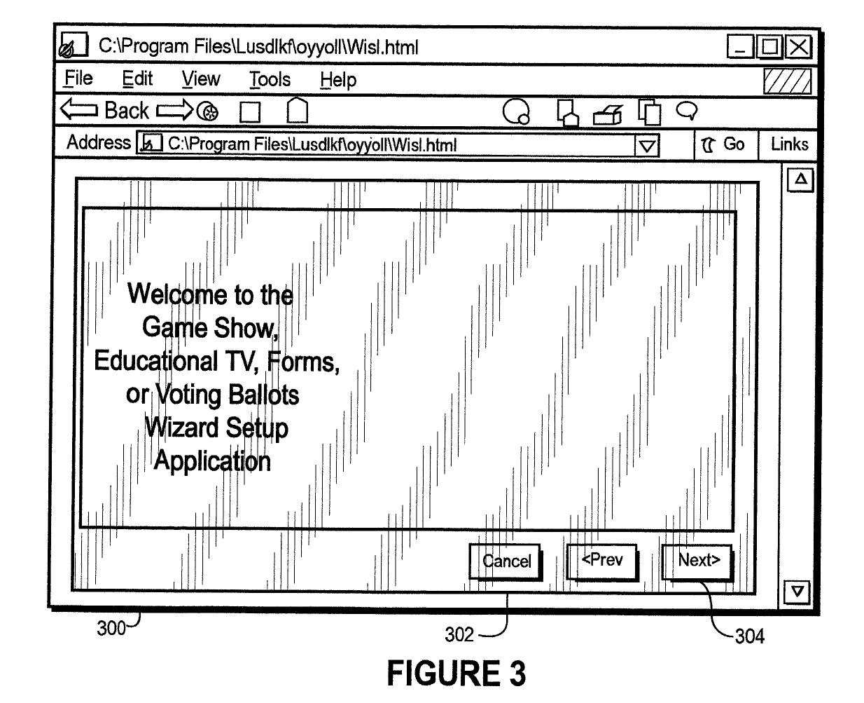

FIGS. 3 through 9 disclose depictions of sample wizards that may be used to prompt the user to enter information to generate HTML display pages. As shown in FIG. 3, a depiction of a screen 300 is provided that illustrates the welcome page 302 for generating HTML display pages for a game show or educational TV show. The welcome page wizard 302 provides several options such as importing XML code, exporting XML code, etc. Additionally, a navigation button 304 can be used to navigate to the next wizard page. The wizard 302 may be accessed by accessing a web site via a browser such as Microsoft Internet Explorer. The web site may store the game wizard program files so that they may be accessed by various users at remote locations using the Internet. Alternatively, the game wizard program files may be stored on a C drive a computer such as illustrated in screen display 300 or a central storage facility of a LAN network.

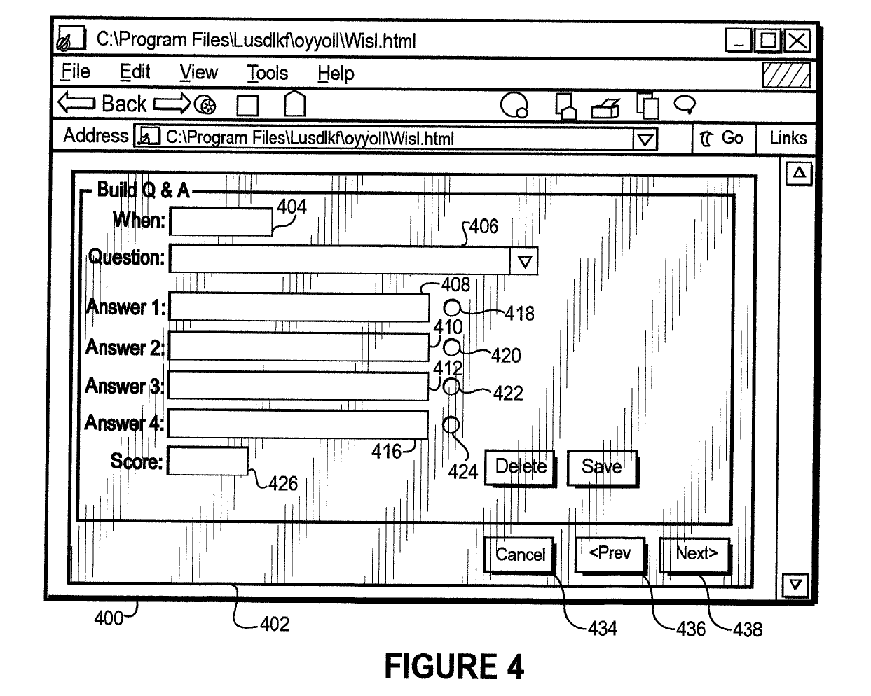

FIG. 4 is an example of another screen display 400 that may be displayed in response to activating the next button 304 (FIG. 3). As shown in this screen display 400, another wizard dialog box 402 is displayed that allows the user to generate certain information relating to a game that will be displayed as a HTML display page in an interactive TV system. The wizard dialog boxes such as wizard dialog box 402 are generated in Microsoft Visual Studio using Visual Basic. These types of wizard dialog boxes are commonly generated by software designers familiar with Visual Basic.

As can be seen from FIG. 4, the wizard dialog boxes prompt the user to enter information in a standard format. For example, wizard dialog box 402 can be used for generating questions and answers that will be displayed on a HTML display page during an interactive TV session. The wizard dialog boxes 402 can be reused to generate a series of questions that may be displayed at different times during the video stream of a TV broadcast. Because the game questions are presented in a standard format, the same wizard dialog boxes can be used from week to week for each weekly show.

As shown in FIG. 4, the wizard dialog box 42 includes various data entry boxes 404-426. In data entry box 404, the elapsed time during the video segment in which the questions are to be displayed on the HTML display page can be entered. In data box 406, the question can be entered by the user. The various answers can be entered in boxes 408, 410, 412, 416. The user can then click on one of the radio buttons 418-424 to indicate the correct answer. The score that can be awarded for a correct answer is entered into data entry box 426 by the user. The export XML button 428 can be activated by the user to send the responses entered into the data entry boxes 404-426 to a XML translator such as XML translator 106 (FIG. 1) to translate the data into XML code. The cancel button 434 is used to cancel the entries provided in data entry boxes 404-426. The previous button 436 can be used to go back to the previous wizard page. The next button 438 can be used to precede to the next wizard page.

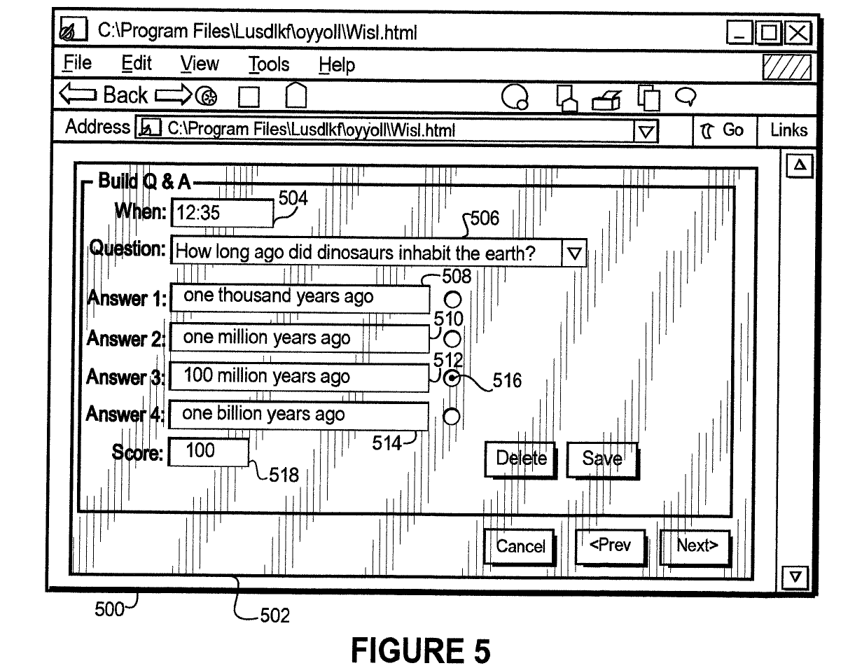

FIG. 5 is a depiction of a screen shot 500 illustrating a completed dialog wizard box such as shown in FIG. 4. In data entry box 504, a time of 12:35 has been entered. This indicates that the series of questions illustrated in wizard box 502 will be displayed on a HTML display page starting 12 minutes, 35 seconds after the start of the video stream. The question which will be displayed is indicated in data entry box 506. The question presented is “How long ago did dinosaurs inhabit the earth?” The wizard dialog box is designed to provide four different answers. As indicated in box 508, answer 1 is “A thousand years ago.” As indicated in data entry box 510, answer number 2 is “A million years ago.” As indicated in data entry box 512, answer number 3 is “A hundred million years ago.” As indicated in data entry box 514, answer number 4 is “A billion years ago.” Radio button 516 has been activated to indicate that the correct answer is answer number 3, “A hundred million years ago.” Data entry box 518 indicates that a score of 100 is awarded for a correct answer.

Alternative embodiments may have an alternative mechanism for determining the position on the video program for the content to become active. Such a mechanism may display the video program on the user's computer and allow the user to play the program to the point that the user wishes to insert the active content. In such an embodiment, the user may fast forward, jog, reverse, and play the program slowly until the user positions the video program at the proper frame for insertion of the interactive content. At this point, the user may indicate that the video is properly positioned and continue with the wizard. The wizard box may have a scroll bar that allows the user to scroll back and forth to find a particular frame of the video program. Other embodiments may allow the user to position the program and display the time or frame number on the screen so that the user may enter the time or frame number into the wizard prompt.

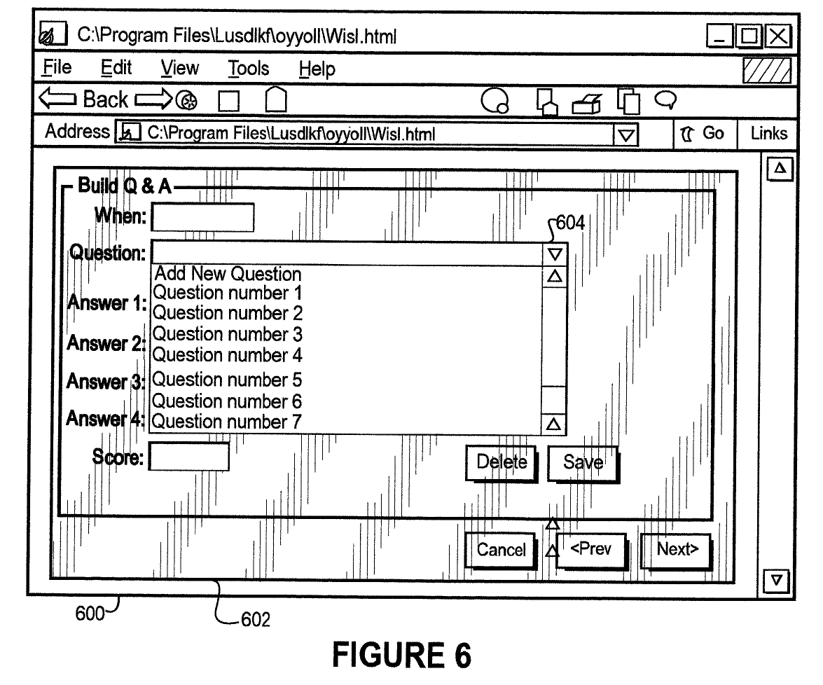

FIG. 6 is another screen depiction 600 of a wizard dialog box 602. As shown in FIG. 6, the wizard dialog box illustrates what occurs when the question pull down menu 604 has been activated. As shown in FIG. 6, a list of representative questions is provided, i.e., “Question number 1, Question Number 2, etc.” The entry “Add a new question” allows the user to start from scratch and add a new question. The fields are blanked when this occurs.

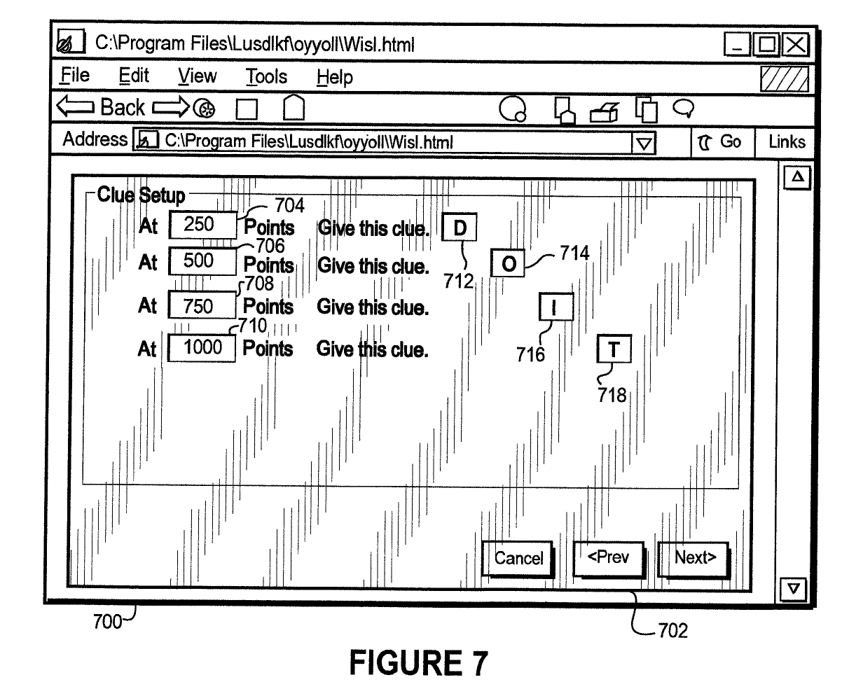

FIG. 7 illustrates a depiction of a screen display 700 having a completed dialog wizard box that allows entry of alphanumeric clues as the viewer reaches specific point levels. In data entry boxes 704-710, the user can enter various increasing levels of points that are required to obtain clues. Each of the alphanumeric clues for each of the various point levels is entered in data entry boxes 712-718. For example, when the viewer reaches 250 points, as indicated in box 704, the viewer obtains the alphanumeric clue D that is entered in box 712. When the viewer reaches an accumulated point total of 500 points, as indicated in data entry box 706, the viewer is provided an alphanumeric clue 0 that is entered in box 714, and so on.

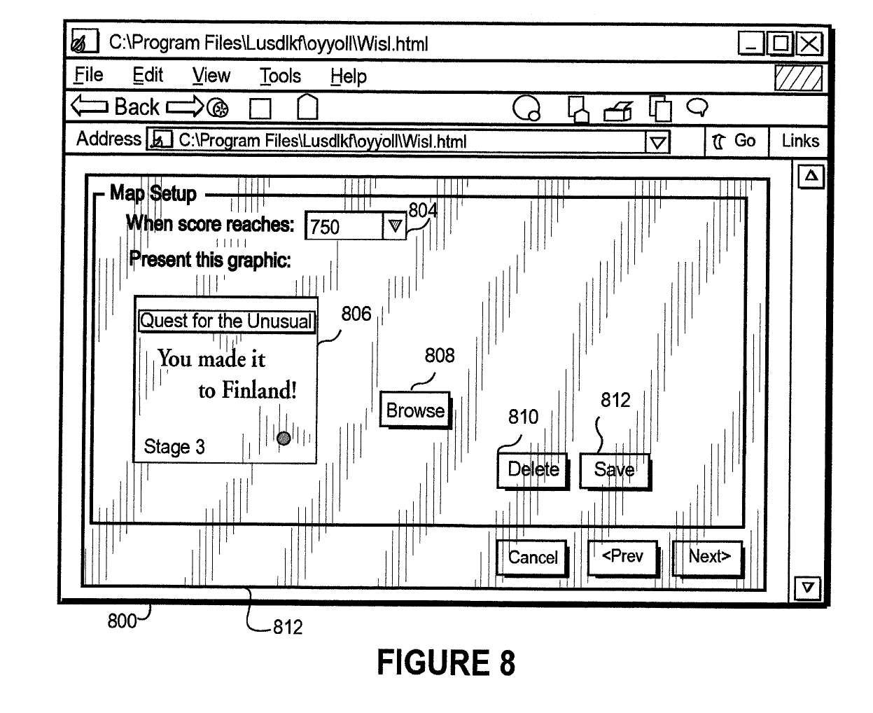

FIG. 8 provides a depiction of a screen shot 800 of an alternative wizard dialog box 802 that can be used for providing clues to a viewer. Using the wizard dialog box 802, the user can enter the number of points to provide a graphic clue. As shown in FIG. 8, the graphic clue is displayed in box 806. The graphic clue is obtained by activating browse button 808 to browse the various stored graphics that are available from the various databases to which the user's computer is connected. Control button 810 allows the user to delete the graphic, while control button 812 allows the user to edit the graphic to change the graphic or add text to the graphic. In this fashion, the wizard dialog box 802 can allow the user to provide various graphical data that can be entered as clues to the viewer when the viewer reaches certain accumulated point levels. Of course, the graphical clues can be used in combination with, or separately from, the alphanumeric clues that are illustrated in FIG. 7.

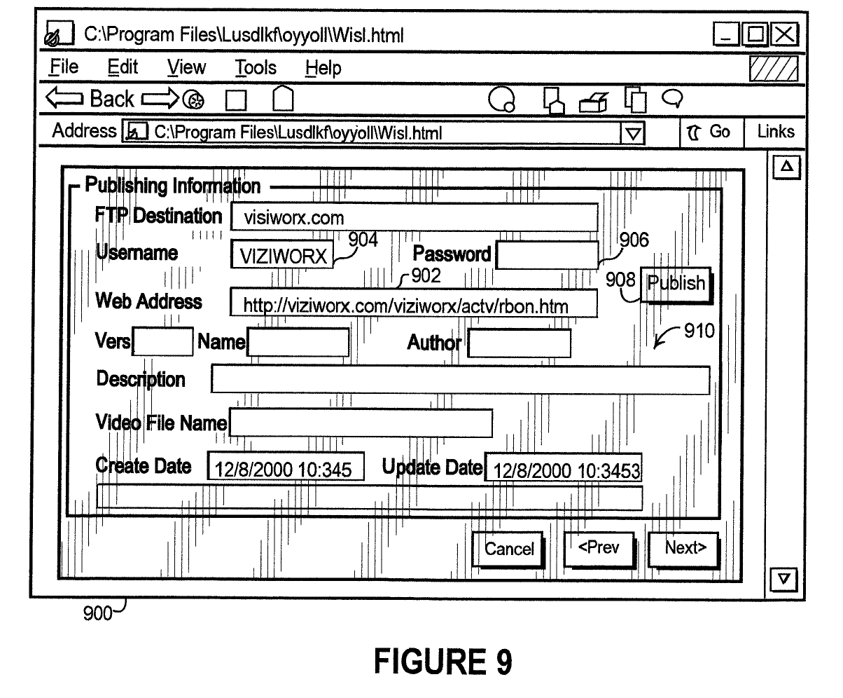

FIG. 9 is a depiction of a publish screen 900. The publish screen 900 provides information relevant to a trigger insertion application, a FTP hosting service domain 902, user name 904 and password 906, a publish button 908, and status field 910 to see what is currently being published.

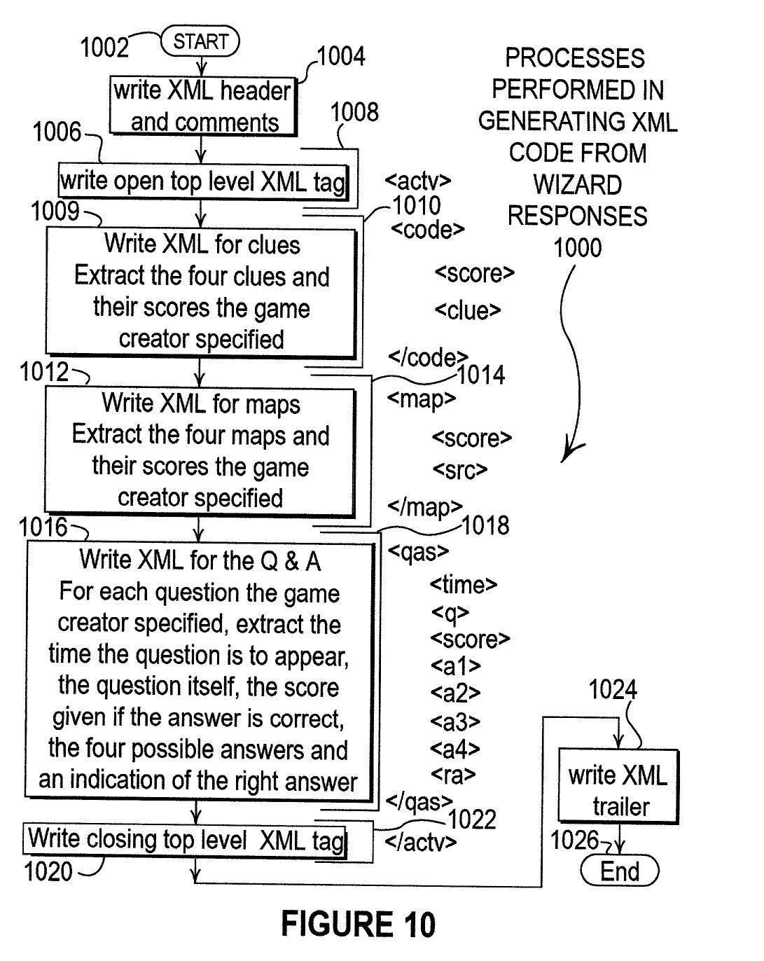

FIG. 10 is a flow diagram illustrating the processes 1000 that are performed in generating XML code from the wizard responses. At step 1002, the process is started. At step 1004, the XML header is written with any desired comments. The XML header is needed to identify the file being created as an XML file as well as which version of XML is being used, the project, number syntax being used, datatypes being used, and other information. The actual XML header is provided below:

<?xml version=“1.0”?>
<iTVStudioProject xmlns:dt+“urn:schemas-microsoft-com:datatypes”>

The comments can simply describe what the XML file is for, who created it, the date, etc. Sample comments are provided below:

<!-- Viziworx Game Wizard XML Schema -->
<!-- Copyright 2000 by Intellocity USA, Inc. -->
<!-- Dec 8, 2000 -->

At step 1006, the open top level XML tag is written. An example is given at 1008 which is “ACTV”. At step 1009, the XML code is written that represents the clues provided in the game wizard. The four clues are extracted together with the score that the user has specified. An example of the XML code is given at 1010. At step 1012, the XML code is written for the graphics such as maps. The four maps are extracted together with the scores that have been provided for each of the maps by the user. An example of the code is given at 1014. At step 1016, the XML code is written for the questions and answers. For each question that was entered by the user, the time at which the question is to appear is extracted along with the content of the question. The correct answer score is also extracted together with the four possible answers and the indication of the correct answer. Sample code is indicated at 1018. At step 1020, the closing top level XML tag is written. An example is given at step 1022. At step 1024, an XML trailer is written. The XML trailer closes or terminates the XML file. A sample XML trailer is given below:

</iTVStudioProject>

At step 1026, the process is ended. The code samples are examples of XML code that define a code segment, map segment and questions and answers (qas) segment. These code segments illustrate the tags that are used. For example, on the question and answer segment there is a <qas> tag indicating a question and answers, the <time> tag that indicates when the question should be displayed, the question itself <q>, the score if the correct answer is chosen <score>, the four possible answers <a1>, <a2>, . . . and the right answer <ra>.

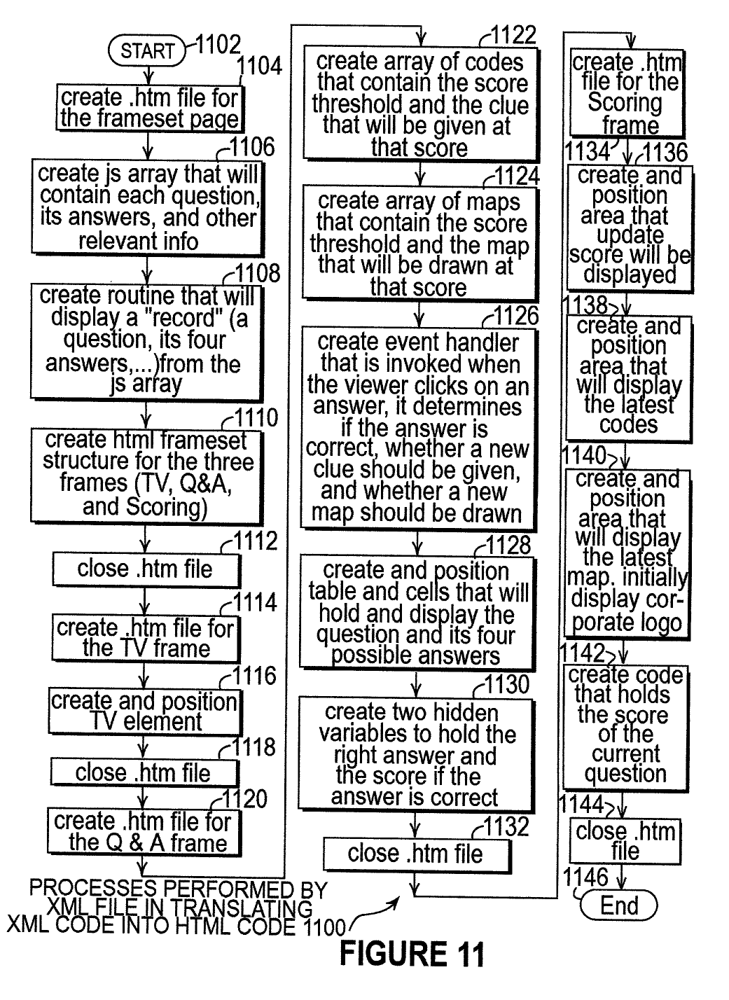

FIG. 11 is a flow diagram of the processes 1100 that are performed by the XSL file in translating the XML code into HTML code. At step 1102, the process is started. At step 1104, the HTML file is created for the frame set page. This includes a comment header that identifies the HTML file that is being prepared as well as a header comment identifying the title, and containing the copyright notice. Other headers can also be written identifying the frame set page as well as HTML tags and title tags. Further, copyright notices and patent notices can also be provided at this step. At step 1106, a Java script array is created that will contain each question with corresponding answers and other relevant information. For example, a Java script header can be created with constants used to identify elements within the question and answer array. A question and answer array header can then be provided. Each question and each answer is tagged in the XML file. The value of each answer is extracted and written to an output file. At step 1108, a routine is created that displays a “record,” e.g., a question and its corresponding answers, from the Java script array. For example, a Java script function is written for displaying a question and its answers. A question extracted from a question and answer array is written to a specified cell within a table in the question and answer frame and sets the color of the specified cell to white. The first answer extractor from the question and answer array is written to a specified cell within a table in the question and answer frame, and the color of that specified cell is set to white. The second answer extractor from the question and answer array is written to a specified cell within a table in the question and answer frame, and the color of that specified cell is set to white. The same process is carried out for the third and fourth answers. The correct answer indicator is written to a variable such as “Txt RA” in the question and answer frame. Similarly, the score for the right answer is written to a variable name “Txt Score” in the question and answer frame. The script tag and the head tag are then written.

As shown in FIG. 11, at step 1110, the HTML frame set structure is created for the three frames (TV, Q&A, and scoring). In other words, the HTML frame set definition is written identifying the placement of the score, the TV and the Q&A frames on the HTML page. The HTML file is then closed by writing the HTML close tag.

At step 1114 of FIG. 11, the HTML file for the TV frame is created. A header comment is generated that identifies the frame set page to which this set of code refers. A tag is then written to identify the start of a new page. A HTML and head tag is written along with a title tag identifying the content. Additionally, copyright and patent notices can be provided. The end of head tag is then written. At step 1116, the TV element is created and positioned on the display. For example, the body tag is written, and the background image is identified for use in this frame. HTML spacers are then generated to indicate the vertical and horizontal size. HTML code is written that creates the TV presentation that is a predetermined number of pixels wide and a predetermined number of pixels high. At step 1118, a close body tag and close HTML tag are written to close the HTML file. As also shown in FIG. 11, at step 1120, a HTML file is created for the question and answer frame. A header comment is generated indicating the frame set page such as “Q&A page”. A tag is then written that is used to identify the start of a new page. The HTML tag is written together with a head tag and a title tag. The title tag is followed by the title of the content of the program. Copyright and patent notices can then be written. At step 1122, an array of codes is created that contain the score threshold and the clue that will be given at that score threshold. A Java script header is written together with a code array header. Values are extracted and written to an output file for every score and single character clue tag in the XML file. At step 1124, an array of maps is created that contain the score threshold and a map that will be drawn at that score threshold. A map array header is first written. The value is extracted and written to an output file for each score and map graphic location tag in the XML file.

As further shown in FIG. 11, at step 1126, an event handler is created that is evoked when the viewer clicks on an answer. The event handler then determines if the answer is correct, whether a new clue should be given and whether a new map should be generated. This is accomplished by writing a Java script function that is evoked whenever a user clicks on an answer. The code is written that checks for the correct answer. The code is also written that updates the score value if the answer is correct. Additional code is written to display the new score. Code is then written to determine if a new map needs to be drawn. Code is provided that determines if the last clue of the four clues needs to be generated as a map. Similar code is written for the third clue, second clue, and first clue. Code is then provided that indicates to the user that the user has selected the incorrect answer. An end script and end tag is then inserted.

At step 1128 of FIG. 11, position tables and cells are created that hold and display the question and the corresponding four possible answers. For example, a body tag is written and the background image is identified that is to be used in the frame. Code is written that generates a spacer to move the image down a certain number of pixels. Additional code is written that creates a table so that when the viewer clicks in a cell an event handler is evoked to react to the click. A cell is written where the question is to be posted. Cells are also written where each of the answers is to be posted, and an end table tag is then inserted. At step 1130 of FIG. 11, two hidden variables are created to hold the correct answer and the score if the viewer selects the correct answer. A close body tag and close HTML tag are then inserted to close the HTML file at step 1132.

At step 1134 of FIG. 11, a HTML file for the scoring frame is created. A header comment is first generated identifying the frame set page such as “score page”. A tag is then written to identify the start of the new page. A HTML tag, a head tag, and a title tag are then inserted. A title indicating the content is inserted together with copyright and patent notices. An end head tag is then inserted to close the header file. A body tag is inserted indicating the background image to be used in the frame. At step 1136, the update score area is created and positioned on the display. Spacers are generated to position the updated score on the display screen. Code is also written to display the latest viewer score by identifying the table name where the score is accumulated.

At step 1138 of FIG. 11, the area for identifying the latest alphanumeric code clues is created and positioned on the display. Spacers are generated to position the display area. Code is then provided that is necessary to display the latest alphanumeric code clues by referencing the proper table in which the code clues have been tabulated. At step 1140, the area for displaying the latest map clues is created and positioned on the display screen, together with a corporate logo identifying the program content, if desired. Again, spacers are generated to locate the maps and predetermined positions on the display screen. Code is also generated that displays the corporate logo by identifying the image name that is to be retrieved.

At step 1142 of FIG. 11, code is created that holds the score of the current question. At step 1144, the HTML file is closed by inserting a close body tag and a close HTML tag. The XSL template processing is then ended at step 1146. In this fashion, the XSL parser provides a set of rules for translating the XML code into the HTML code for a particular interface.

The present invention has employed frame set structures for generating the HTML code over tables to minimize repainting and allow for more accurate placement of individual elements. The questions, possible answers, correct answer indication score, and the time for presenting the questions and answers are placed in an array and downloaded to the viewer's set-top box. Further, the XML schema was developed based upon what is needed to generate the HTML/Java script pages and trigger information.

The basic approach for the user who creates the HTML pages is given below. The user first logs in, obtains a list of projects already created, and has the option of editing an existing project or creating a new one. For a new project, the user enters a question and time that it should be shown to the viewer. Four possible answers are then entered with an indication of which answer is correct. A correct answer score is then assigned, and this information is then saved. Another question is then entered until the process is complete. A score threshold is entered together with a clue. This process is repeated several more times increasing the score threshold each time. A score threshold can then be entered with a map graphic. This process can also be repeated for increasing score thresholds each time.

For editing an existing project, the user selects the project to edit and makes necessary changes, additions, or deletions to the questions, answers, clues, or maps. At the end of this process, an indication can be provided that the process is complete.

The user then provides a command to generate the XML file. The XML file is passed through the XSL parser to generate the appropriate HTML and Java script. A FTP transfer is then performed to transfer the XML, HTML, Java script, and graphics to a web server that is ready to be accessed by the viewer's set-top box. To lay out the user interface presentation, e.g. the wizard dialog boxes, a person generating the code may utilize the Microsoft Visual Basic application to create such layouts. For example, a code generator may access the following web site: http://msdn.microsoft.com/vbasic/prodinfo/datasheet/default.asp. The code generator would indicate new project and ActiveX control. Large windows such as illustrated in FIGS. 4 through 9 can be generated to layout each of the elements of the wizard boxes. Five different screens can be created for each separate presentation such as the welcome screen, questions and answers, maps, clues, and publish wizard boxes. Navigation can then be provided between the boxes. For example, as shown in FIG. 3, the welcome screen may include a next box. Next, each of the screens can be customized. The welcome screen can be customized to include welcome text and graphics. The question and answer screen, as shown in FIGS. 4 and 5, can include a combo box, data grid, text field for question, and four text fields for answers, with each answer having a radio button indicating which answer is correct. With regard to the map screen as shown in FIG. 8, a graphic map viewing area was provided together with a combo box listing all of the maps assigned thus far, a score text box, and a save button. The clues screen for alphanumeric clues, as shown in FIG. 7, was generated with four text areas and four single character text entry fields.

The present invention also provides the necessity for database connectivity. In that regard, a table structure is defined for projects, questions and answers, maps, and clues. For projects, a listing is provided of all projects sorted by date with name, description, video source, and run date. For questions and answers, a table is provided of questions, times the questions will be shown to a viewer, and answers and scores joined to a specific project. For maps, a table is provided of scores and the associated maps that are joined to a specific project. For clues, a table of scores is provided with the respective clues that are joined for a specific project, such as a particular game or episode of a show that is being enhanced.

The next step for providing database connectivity is to create a database using Microsoft access and publish the data to a SQL server database. Standard techniques for performing this process are used.

The next step in providing database connectivity is to prepare the necessary code. In that regard, the database is opened, and the projects table is queried to build a list of existing projects from which the user can work. When the user selects an existing project, a list of questions and answers is retrieved from the Q&A table via a SQL statement. For example, such a SQL statement maybe SELECT * FROM qas WHERE qas.qaPjID=thePjID. The list of questions and answers from the Q&A table is then saved.

The next step is to retrieve a list of maps from the map table via a SQL statement. Such a SQL statement may be SELECT * FROM mps WHERE mps.mpPjID=thePjID. The list of maps retrieved from the map table is then saved. A similar process is used to retrieve the list of clues from the clues table. The user can then proceed to make any necessary changes.

When the user is ready to save the game information back in the database the user first creates a SQL update statement for a projects table that will update an existing record or create a new projects record. Next, a SQL update statement is created for a question and answer table that will update an existing record or create a new question and answer record. Then, a SQL update statement is created for a maps table that will update an existing maps record or create a new maps record. Further, a SQL update statement is created for a clues table that will update the existing clues record or create a new clues record. In this fashion, database connectivity is provided.

To adapt the system to various interfaces such as WebTV, AOLTV, or other set-top box interfaces, simple procedures can be used. First, the application is coded for the particular interface such as WebTV, AOLTV, etc. A new XSL parser is then created for that particular interface. The code is then modified such that after it creates the XML file, the XML file is passed through each of the different XSL parsers such as indicated at 110, 114, 118 of FIG. 1.

Those skilled in the art will understand that the present invention is not limited to the creation of games for interactive television, but are adapted to the creation of any interactive content that can be displayed on an interactive television. The invention may comprise a wizard that allows the user to create forms for the collection of data, such as order forms and collecting addresses of the viewer. Such a wizard may include tools for creating input boxes and text that would be placed on the form. Further, the wizard may allow the user to add sounds, change appearances, and otherwise design the interactive content using the wizard.

Other applications for the present invention include the creation of interactive polling and voting content. Such content may include a question with several answers. The viewer would be prompted by the questions and answers to vote during the course of the program. A voting ballot may prompt the viewer to choose one of several choices. Additional uses of this type of interactive television may be for educational applications where the viewer is asked to complete several test questions to ensure that the viewer has learned the required content from the video program. The questions may be multiple choice, true/false, or other types of questions.

The present invention therefore provides a system for generating wizards that prompt a user for information to generate a HTML display page. The prompting wizards provide a standard format that can be utilized by non-technical users to both generate and edit input content. The content can be used to generate HTML pages that are usable with various HTML interfaces such as various different types of set-top boxes. In this fashion, expensive specialized code writers are not required to generate HTML pages for use in an interactive TV environment.

The foregoing description of the invention has been presented for purposes of illustration and description. It is not intended to be exhaustive or to limit the invention to the precise form disclosed, and other modifications and variations may be possible in light in the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A wizard for creation of interactive television content comprising:
a graphical user interface;
a prompt for identifying content to be entered;
an input box for collecting said content to be entered;
a prompt for identifying the start time; said start time being the time in the program that said content will be displayed; and
an input box for collecting said time.

2. The wizard of claim 1 further comprising:
a translator for generating an XML file comprising said content.

3. The wizard of claim 2 further comprising:
an XSL parser for generating an HTML file.

4. The wizard of claim 3 wherein said XSL parser is adapted to generate an HTML file for a first output device.

5. The wizard of claim 4 wherein a second XSL parser is adapted to generate an HTML file for a second output device.

6. The wizard of claim 1 adapted to create content for a game show.

7. The wizard of claim 1 adapted to create content for voting using interactive television.

8. The wizard of claim 1 adapted to create a form for collecting viewer input.

9. A software structure for the creation of interactive television content comprising:
a mechanism for selecting a particular frame of a video program; and
a wizard for collecting content, said wizard comprising a graphical prompt for identifying content to be entered by a user, and an input box for collecting content entered by said user.

10. The software structure of claim 9 further comprising:
a translator for translating said content into XML.

11. The software structure of claim 10 further comprising:
a first XSL parser adapted to generate HTML code for a first display device.

12. The software structure of claim 11 further comprising:
a second XSL parser adapted to generate HTML code for a second display device.

13. A software structure for the creation of content that can be displayed on multiple HTML interfaces comprising:
a prompting wizard for collecting content from a user;
a translator for translating said content into XML code; and
a plurality of XSL parsers for translating said XML code into HTML code for a plurality of devices for displaying HTML code.

14. A software system used by non-technical users for creating HTML code for a plurality of display devices comprising:
a graphical prompt for soliciting user input;
a translator for translating said user input into XML code; and
a first XSL parser for translating said XML code into HTML code for a first HTML display device.

15. The software system of claim 14 further comprising:
a second XSL parser for translating said XML code into HTML code for a second HTML display device.

16. A software structure for allowing non-technical users to enter content that can be displayed on various interactive television systems comprising:
input graphics for prompting said user to insert the desired content to be displayed on an HTML page;
a translator for translating said content into XML code;
a first XSL parser for translating said XML code into HTML code for a first interactive television system; and
a second XSL parser for translating said XML code into HTML code for a second interactive television system.

17. A method of creating interactive content for a television program comprising:
selecting a frame during said television program to display content;
using a graphical interface to capture said content;
translating said content into XML;
parsing said XML using a first XSL parser into HTML code;
displaying said HTML code with said television program in an interactive fashion on a first device.

18. The method of claim 17 further comprising:
parsing said XML using a second XSL parser into HTML code;
displaying said HTML code with said television program in an interactive fashion on a second device.

19. A method of generating HTML pages for a plurality of interactive television systems by non-technical users comprising the steps of:
entering content information to be displayed on said HTML pages in a graphical user interface;
translating said content information into XML code;
translating said XML code into HTML code for a first interactive television system using a first XSL parser; and
translating said XML code into HTML code for a second interactive television system using a second XSL parser.
